(19) United States
(12) Patent Application Publication
(10) Pub. No.: US 2006/0077634 A1
(43) Pub. Date: Apr. 13, 2006

(54) Protecting device for connectors of computer

(75) Inventors: Yun-Lung Chen, Tu-Cheng (TW); Zhou Xu, Shenzhen (CN); Jun Tang, Shenzhen (CN); Shao-Bin Zhang, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/225,793

(22) Filed: Sep. 13, 2005

(30) Foreign Application Priority Data
Sep. 24, 2004 (CN) 200420093612.1

(51) Int. Cl. G06F 1/16

(52) U.S. Cl. 361/686

(57) ABSTRACT

A protecting device for enclosing cable connectors of a computer includes a rear panel (10) of a computer chassis, a first member (20) and a second member (30). The rear panel has a plurality of I/O ports (102) for the cable connectors inserting thereinto. The first member has a first rear wall. The second member is attached to the rear panel by a second hook. The second member has a second rear wall and a cap around the second hook. The first rear wall is coupled with the second rear wall for enclosing the cable connectors. The cap encloses the second hook with the rear panel.

### BACKGROUND OF THE INVENTION

1. Field of the Invention

The present invention relates to protecting devices, and more particularly to a protecting device for cable connectors which are secured to a rear panel of a computer chassis.

2. General Background

Many peripheral equipments, such as mouse, keyboard, USB and moveable hard disk drive, are coupled to a computer with cable connectors through I/O ports. Usually, the cable connectors are very easily removed from the computer.

A cable connector is plugged into a socket on a chassis of an electronic device. A bracket is provided for enclosing the connector therein. The bracket has a first generally U-shaped member and a second generally U-shaped member. A first fastener connects the first member to the second member so that the connector is enclosed between the first and second members. A second fastener secures at least one of the first and second U-shaped members to the chassis of the electrical device. However, there are not protecting devices disclosed for preventing the bracket from being exteriorly removed.

What is needed, therefore, is a protecting device which protects cable connectors of the peripheral equipments from unwanted removal.

### SUMMARY

A protecting device for enclosing cable connectors of a computer includes a rear panel of a computer chassis, a first member and a second member. The rear panel has a plurality of I/O ports for the cable connectors inserting thereinto. The first member has a first rear wall. The second member is attached to the rear panel by a second hook. The second member has a second rear wall and a cap around the second hook. The first rear wall is coupled with the second rear wall for enclosing the connectors. The cap encloses the second hook with the rear panel.

Other objects, advantages and novel features of the invention will become more apparent from the following detailed description when taken in conjunction with the accompanying drawings, in which:

### BRIEF DESCRIPTION OF THE DRAWINGS

FIG. 1 is an exploded, isometric view of a protecting device of a preferred embodiment of the present invention, the protecting device including a first member, a second member and a rear panel;

FIG. 2 is another isometric view of the first member and the second member;

FIG. 3 is similar to FIG. 1, but showing the first member secured to the rear panel;

FIG. 4 is an assembled view of FIG. 1;

FIG. 5 is similar to FIG. 4, but viewed from another aspect;

FIG. 6 is an alternative embodiment of the first member of FIG. 1;

FIG. 7 is an alternative embodiment of the second member of FIG. 1; and

FIG. 8 is an assembled view of the alternative embodiment of the first member and the second member.

### DETAILED DESCRIPTION OF THE INVENTION

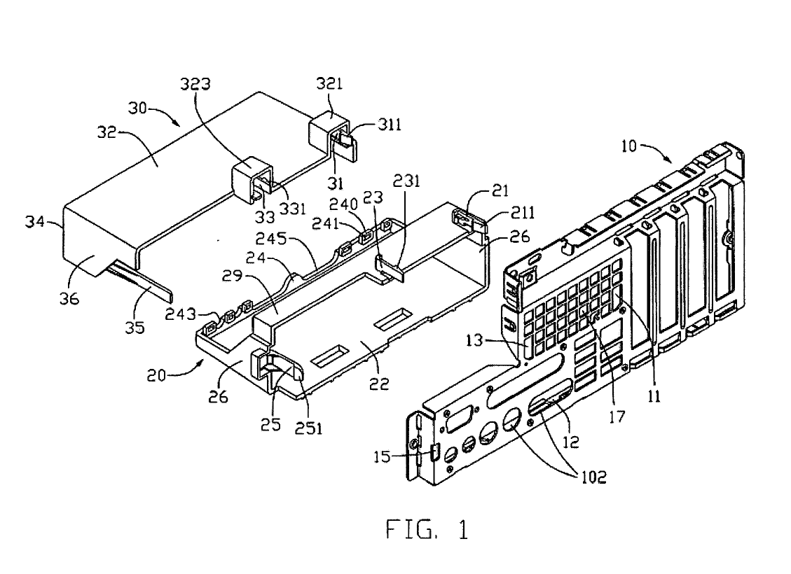

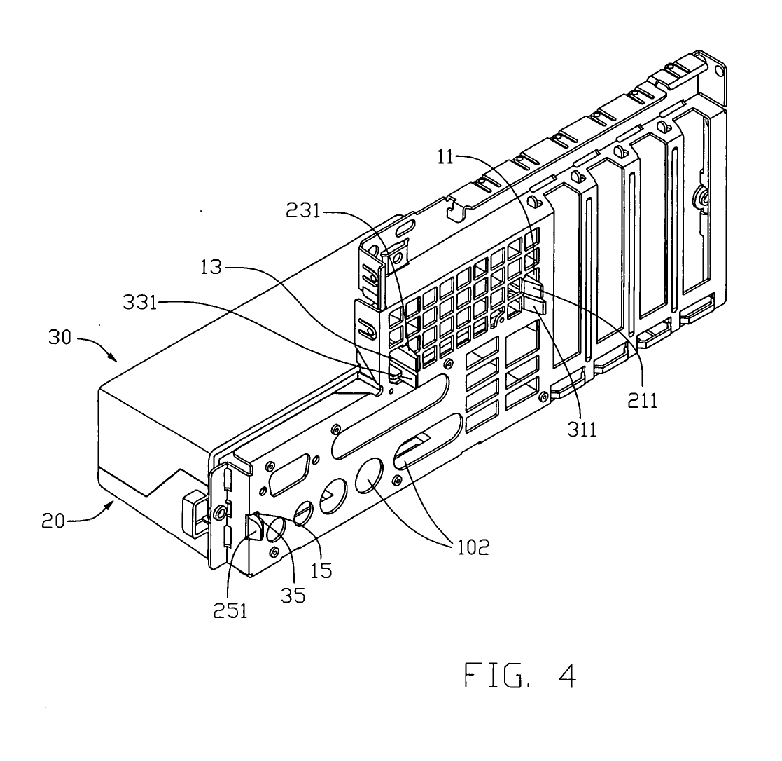

Referring to FIGS. 1 to 5, a protecting device in accordance with a preferred embodiment of the present invention includes a rear panel 10 of a chassis of an electronic device like a computer and a protecting cage including a first member 20 and a second member 30.

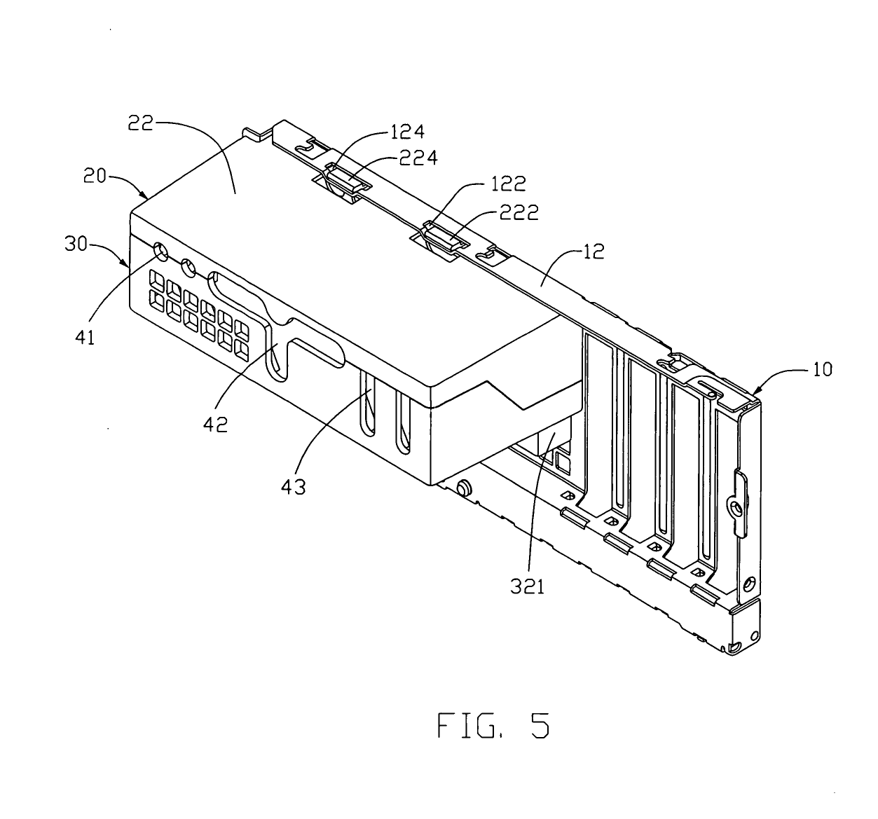

A plurality of I/O ports 102 is defined in the rear panel 10. A mounting hole 15 is defined at an end of the rear panel 10. A plurality of ventilation holes 17 is defined above the I/O ports 102. Two securing holes 11, 13 are defined at two sides of the ventilation holes 17. A bent flange 12 extends from a bottom edge of the rear panel 10. Two latching opening 122, 124 are defined in the bent flange 12, as shown in FIG. 5.

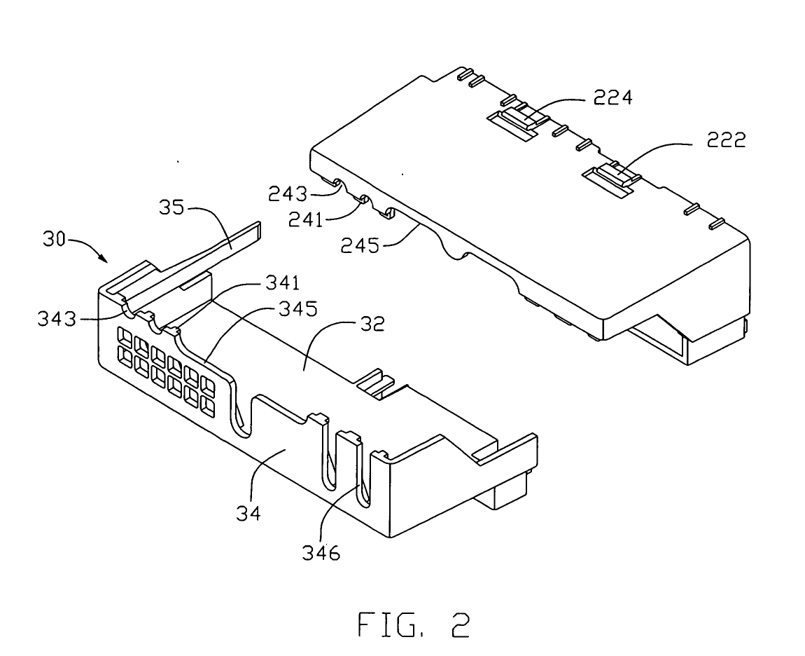

Referring to FIGS. 1 and 2, the first member 20 includes a bottom wall 22 and a pair of side walls 26 extending upwardly and perpendicularly from opposite edges of the bottom wall 22. A pair of retaining hooks 222, 224 protrudes from the bottom wall 22 for engaging in the latching opening 122, 124, as shown in FIG. 5. A mounting hook 25 extends from the side wall 26 corresponding to the mounting hole 15 of the rear panel 10. A wedge portion 251 is formed at a free end of the mounting hook 25. A top plate 29 bestrides the pair of side walls 26. A pair of locking hooks 21, 23 is formed on the top plate 29 corresponding to the securing holes 11, 13 respectively. The locking hooks 21, 23 each have a wedge portion 211, 231. The wedge portions 211, 231 are disposed face to face. A first rear wall 24 protrudes perpendicularly from the bottom wall 22 between the pair of side walls 26. A plurality of indented positioning blocks 240, each having a positioning hole 241, is formed at an upper edge of the first rear wall 24. A plurality of hemicycle-shaped cutouts 243 and elongated cutouts 245 are defined in the first rear wall 24 between the adjacent positioning blocks 240.

The second member 30 includes a top wall 32 and a pair of side walls 36 extending downwardly and perpendicularly from opposite edges of the top wall 32. A pair of shielding caps 321, 323 protrudes from the top wall 32. A pair of locking hooks 31, 33 extends forward from the shielding caps 321, 323 respectively, corresponding to the securing holes 11, 13 of the rear panel 10. The locking hooks 31, 33 each have a wedge portion 311, 331. The wedge portions 311, 331 are disposed face to face. An elongated lever 35 extends from an inner surface of the side wall 36 for squeezing the mounting hook 25 of the first member 20. A second rear wall 34 extends perpendicularly from an edge of the top wall 32 between the pair of side walls 36. A plurality of catches 341 protrudes from the second rear wall 34, corresponding to the positioning holes 241 of the first member 20. A plurality of hemicycle-shaped cutouts 343, a T-shaped cutout 345 and a plurality of elongated cutouts 346 are defined in the second rear wall 34.

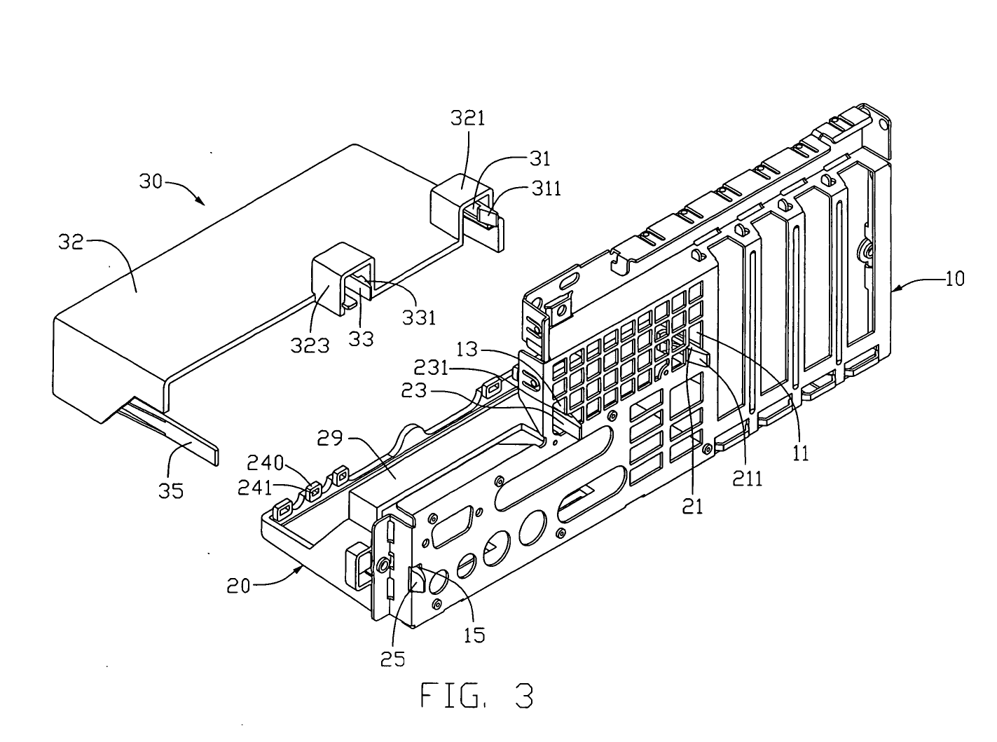

Referring to FIGS. 3 to 5, the retaining hooks 222, 224 are received into the latching opening 122, 124. Then, the mounting hook 25 and the locking hooks 21, 23 insert into the mounting hole 15 and bottom portions of the securing holes 11, 13 respectively along an exclusive inserting direction due to limitation of the retaining hooks 222, 224. The wedge portions 211, 231 of the locking hooks 21, 23 are engaging with the edges of the securing holes 11, 13 respectively to mount the first member 20 on the rear panel 10, as shown in FIG. 3.

The second member 30 is placed on the first member 20 with the top plate 29 abutting against the top wall 32. The second member 30 is then pushed to slide along the first member 20 towards the rear panel 10. The catches 341 of the second member 30 are inserted into the positioning holes 241 of the positioning block 240 of the first member 20. The elongated lever 35 is inserted into the mounting hole 15, so that the mounting hook 25 is squeezed by the elongated lever 35, and the wedge portion 251 of the mounting hook 25 engages with the edge of the mounting hole 15 tightly. At the same time, the locking hooks 31, 33 of the second member 30 are inserted into top portions of the securing holes 11, 13 respectively. The wedge portions 311, 331 of the locking hooks 31, 33 engage with the edges of the securing holes 11, 13 respectively to mount the second member 30 on the rear panel 10. The I/O ports 102 of the rear panel 10 are enclosed by the first member 20 and the second member 30. The caps 321 and 323 enclose the hooks 21, 31, 23 33 to present the first member 20 and the second member 30 being exteriorly removed from the rear panel 10. The first rear wall 24 of the first member 20 matches the second rear wall 34 of the second member 30. As shown in FIG. 5, the hemicycle-shaped cutouts 243 of the first member 20 join with the hemicycle-shaped cutouts 343 of the second member 30 to form a plurality of round through slots 41. The elongated cutout 245 joins with the T-shaped cutout 345 to form a T-shaped through slot 42. The cutouts 346 of the second member 30 are blocked by the first rear wall 24 of the first member 20, thereby forming a plurality of elongated through slots 43.

In disassembly, the locking hooks 31, 33 of the second member 30 is deformed to disengage from the securing holes 11, 13 of the rear panel 10 with hands inside the chassis. The second member 30 is thus pushed to slide from the first member 20.

In use, the first member 20 is firstly mounted to the rear panel 10 of the computer chassis. A plurality of cable connectors of peripheral equipments is coupled to the I/O ports 102 of the rear panel 10. The cables of the peripheral equipments can be distributed in the cutouts 243, 245 of the first member 30 respectively. The second member 30 is then mounted to the rear panel 10 for matching the first member 20. The cable connectors are enclosed in the protecting cage formed by the first member 20 and the second member 30, so that the cable connectors cannot be removed outside.

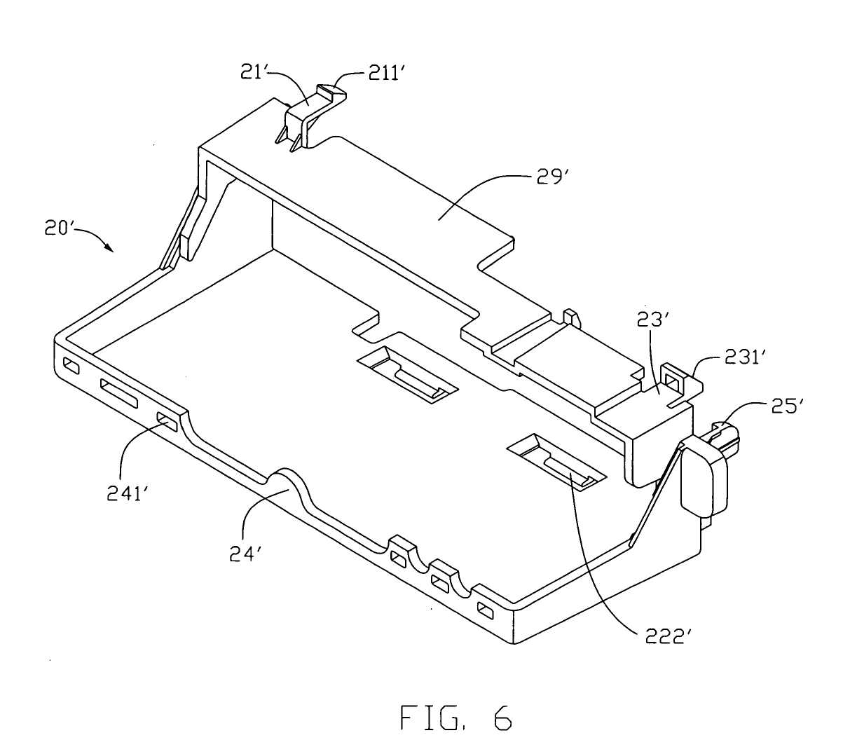

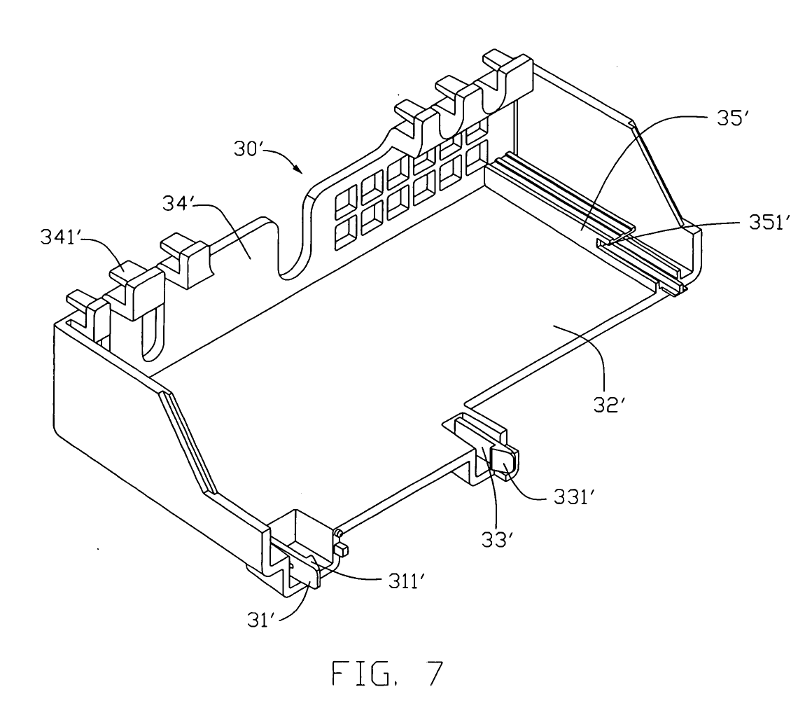

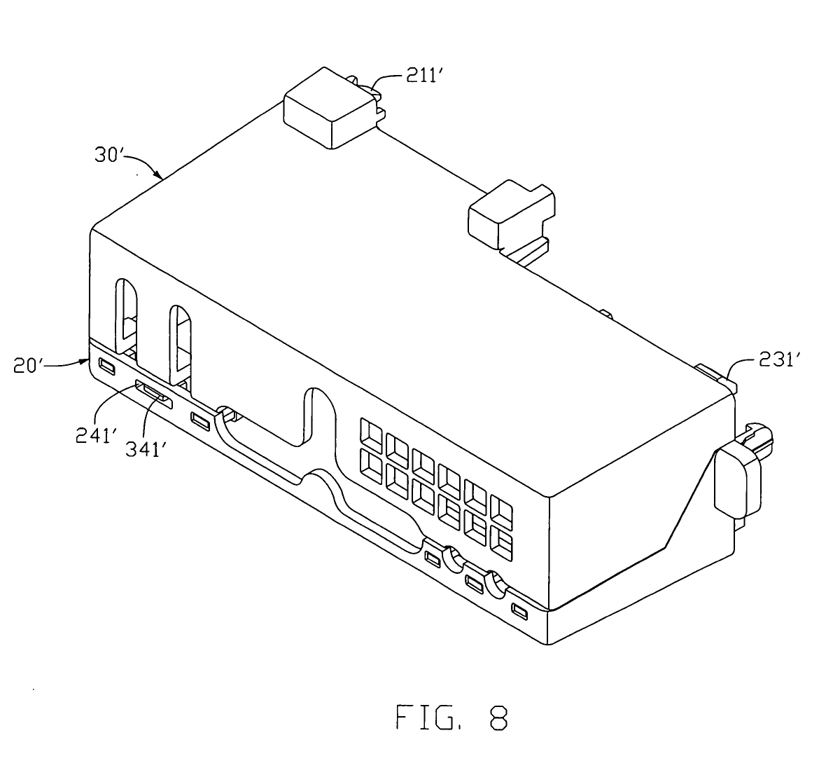

Referring to FIGS. 6, 7 and 8, an alternative embodiment of the present invention is shown. The alternative embodiment is generally similar to the previous.

In the alternative embodiment, the second member 30′ is matched to the first member 20′ in another form. A bottom of a second rear wall 34′ is bent inwards, then downwards and outwards to form a plurality of U-shaped catches 341′. Corresponding to the catches 341′, a plurality of positioning holes 241′ are defined in the first rear wall 24′. A clip 35′ with a recess 351′ is formed on the inner surface of the top wall 32′.

Firstly, the first member 20′ is mounted to the rear panel 10′ with the retaining hooks 222′, the mounting hook 25′, and the locking hooks 21′, 23′. The catches 341′ of the second member 30′ is inclined and inserted into the openings 241′ from inner space of the first member 20′. Then the second member 30′ is pivoted about the catches 341′ in the openings 241′, until the second member 30′ covers the first member 20′. The second member 30′ is pushed forwards. An edge of the top plate 29′ of the first member 20′ is received in the recess 351′ of the clip 35′ to stably join the first member 20′ and the second member 30′ together. At the same time, the locking hooks 31′, 33′ are engaged on the rear panel 10′ to secure the second member 30′ on the rear panel 10′.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

We claim:

1. A protecting device for enclosing cable connectors of a computer, comprising:
a rear panel of a computer chassis having a plurality of I/O ports for the cable connectors inserting thereinto;
a first member having a first rear wall; and
a second member with a second hook for attaching the second member to the rear panel, the second member having a second rear wall and a cap around the second hook;
wherein the first rear wall is coupled with the second rear wall for enclosing the cable connectors, and the cap encloses the second hook with the rear panel.

2. The protecting device as described in claim 1, wherein the first rear wall has at least one first cutout, and the second rear wall has at least one second cutout joining with the first cutout to provide passage for cables of the cable connectors.

3. The protecting device as described in claim 1, wherein a plurality of positioning holes are defined in the first member, and a plurality of catches are formed on the second member for engaging in the positioning holes.

4. The protecting device as described in claim 3, wherein the catches are U-shaped.

5. The protecting device as described in claim 1, wherein the second member comprises a clip with a recess defined for clipping the first member.

6. The protecting device as described in claim 1, wherein a top plate is formed on the first member, and a top wall is formed on the second member to couple with the top plate.

7. The protecting device as described in claim 1, wherein the first member has a first hook, and a plurality of holes is defined in the rear panel for the first and second hooks engaging with.

8. The protecting device as described in claim 7, wherein a lever protrudes from the second member for inserting into one of the plurality of the holes of the rear panel to have the first hook therein tightly secured.

9. The protecting device as described in claim 1, wherein the first hooks each have a wedge portion, and the wedge portions of first hooks are disposed face to face.

10. The protecting device as described in claim 1, wherein the second hooks each have a wedge portion, and the wedge portions of second hooks are disposed face to face.

11. The protecting device as described in claim 1, wherein the rear panel comprises a bent flange having a plurality of latching openings defined therein, and a plurality of retaining hooks protrudes from the first member to engage in the latching opening.

12. A protecting device for enclosing cable connectors of a computer, comprising:
a rear panel of a computer chassis having a plurality of I/O ports for the cable connectors inserting thereinto, a plurality of holes being defined in the rear panel;
a first member comprising a pair of hooks each with a wedge portion engaging with the hole of the rear panel for securing the first member to the rear panel, the hooks' wedge portions being disposed face to face; and
a second member coupled to the first member for enclosing the cable connectors, the second member comprising a pair of hooks each with a wedge portion engaging with the hole of the rear panel for securing the first member to the rear panel, the hooks' wedge portions being disposed face to face.

13. The protecting device as described in claim 12, wherein the first member has at least one first cutout, and the second member has at least one second cutout matching with the first cutout to provide passage for cables of the cable connectors.

14. The protecting device as described in claim 12, wherein a plurality of positioning holes are defined in the first member, and a plurality of catches are formed on the second member for engaging in the positioning holes.

15. The protecting device as described in claim 14, wherein the catches are U-shaped.

16. The protecting device as described in claim 14, wherein the second member comprises a clip with a recess defined for clipping the first member.

17. The protecting device as described in claim 12, wherein a lever protrudes from the second member for inserting into one of the plurality of the holes of the rear panel to have the hook therein tightly secured.

18. An electronic device comprising:
a chassis enclosing said electronic device therein, and defining a rear panel exposable to an outside of said chassis for further connection with said electronic device;
a plurality of cable connectors capable of electrically connecting onto said rear panel for establishing said further connection with said electronic device and extendable in said outside of said chassis; and
a protecting device engagably attachable to said rear panel and capable of enclosing around extension of said plurality of cable connectors in said outside of said chassis, at least one retaining means formed at a side of said protecting device and capable of retainably engaging with said rear panel to confine movement of said protecting device toward said rear panel along an exclusive direction, and at least one locking means formed at said protecting device other than said side and capable of engaging with said rear panel to fix said protecting device onto said rear panel when said protecting device moves along said exclusive direction after retainable engagement of said at least one retaining means and said rear panel.

19. The electronic device as described in claim 18, wherein said protecting device comprises two separable members, and said at least one retaining means is defined at a side of a first one of said two members, and said at least one locking means is formed at said first one of said two members other than said side of said first one of said two members.

20. The electronic device as described in claim 19, wherein a second one of said two members comprises a plurality of catches protruding from a rear wall of said second one of said two members to be engagable with said first one of said two members so as to confine movement of said second one of said two members toward said rear panel along another exclusive direction, and comprises a pair of locking hooks extending from a top wall of said second one of said two members to be fixedly engagable with said rear panel along said another exclusive direction.
